(19) United States
(12) Patent Application Publication
(10) Pub. No.: US 2022/0314694 A1
(43) Pub. Date: Oct. 6, 2022

(54) Easy Wheel Mount

(71) Applicant: Kenneth Bell, Amarillo, TX (US)

(72) Inventor: Kenneth Bell, Amarillo, TX (US)

(21) Appl. No.: 17/702,112

(22) Filed: Mar. 23, 2022

Related U.S. Application Data
(63) Continuation-in-part of application No. 17/219,419, filed on Mar. 31, 2021.

(51) Int. Cl. B60B 29/00

(52) U.S. Cl. CPC B60B 29/002

(57) ABSTRACT

A tire changing device for lifting and positioning a tire, providing rolling members allow for easy vertical adjustment of the tire and whose shape enables a tire to be conveniently rolled on, positioned and retained thereon. The tire mounting device for mounting a tire to a vehicle, includes a lower frame comprising caster wheels and raising and lowering devices which act in concert via a common control. The disclosed device also includes an upper platform in communication with a lower platform configured to be raised and lowered thereby to a height of a wheel hub to receive the tire via a scissor lift. The device further includes a pair of rollers having an adjustable space there between less than a diameter of a wheel to be mounted to a vehicle to enable a tire rotation to align wheel hub lugs to rim lug holes.

### BACKGROUND

In order to change tires on a vehicle, the tire must be lifted off the hub once the nuts have been removed from the studs extending from the hub. Conversely, the replacement tire must be lifted back for proper positioning during mounting of the tire on the hub. Traditionally, such lifting and positioning has been done manually. However, in numerous cases the tires are too heavy and/or too unwieldy to allow for efficient and quick changing by a single person. Many people have found themselves down on the floor with the tire on their feet trying to lift it into position. Creating an uncomfortable and an inconvenient way of trying to replace a tire effectively. There have been no products available as original equipment or as an aftermarket to address this problem.

Specifically, an apparatus to simplify the process of changing a tire such as lifting and positioning the tire is not available as original equipment or as an aftermarket product to address this problem either.

Therefore, there exists a need for a device such as above, that is not being met by any known or disclosed device or system of present on the market.

### SUMMARY OF THE INVENTION

The present invention is designed to assist in mounting a tire to a vehicle. This apparatus invention is used in overcoming the above referred to difficulties in a convenient, simple and efficient manner. The tire mounting device for mounting a tire to a vehicle, includes a lower frame comprising caster wheels and raising and lowering devices which act in concert via a common control. The disclosed device also includes an upper platform in communication with a lower platform configured to be raised and lowered thereby to a height of a wheel hub to receive the tire. The device further includes a pair of rollers spaced apart an adjustable space there between less than a diameter of a wheel to be mounted to a vehicle, the pair of adjustable rollers enabling a tire rotation to align wheel hub lugs to rim lug holes. Additionally, a scissor lift moves the upper platform from the bottom platform to align a wheel hub lug to a rim lug hole, wherein the scissor lift comprises two crossing members adjustable in relation to each other and to the support frame.

### BRIEF DESCRIPTION OF THE DRAWINGS

FIG. 1. This is a perspective view of the Easy Wheel Mount apparatus in accordance with an embodiment of the present disclosure.

FIG. 2 is a perspective view of an improved Easy Wheel Mount apparatus in accordance with an embodiment of the present disclosure.

Throughout the description, similar reference numbers may be used to identify similar elements depicted in multiple embodiments. Although specific embodiments of the invention have been described and illustrated, the invention is not to be limited to the specific forms or arrangements of parts so described and illustrated. The scope of the invention is to be defined by the claims appended hereto and their equivalents.

### DETAILED DESCRIPTION

Reference will now be made to exemplary embodiments illustrated in the drawings and specific language will be used herein to describe the same. It will nevertheless be understood that no limitation of the scope of the disclosure is thereby intended. Alterations and further modifications of the inventive features illustrated herein and additional applications of the principles of the inventions as illustrated herein, which would occur to one skilled in the relevant art and having possession of this disclosure, are to be considered within the scope of the invention.

Throughout the present specification, the word ‘cam’ refers to a bolt like component part of the disclosure which rides on a threaded shaft or threaded rod without turning and is hingedly connected to crossing members so to allow a distance between crossing members to be changed and a height thereof to be moved together with the disclosed platform to match a wheel and a wheel hub height. The term crossing members refers to a scissor lift and either a juncture thereof or to respective and similar ends of the members thereof enabling matching a height of a wheel on a vehicle to be removed and reassembled.

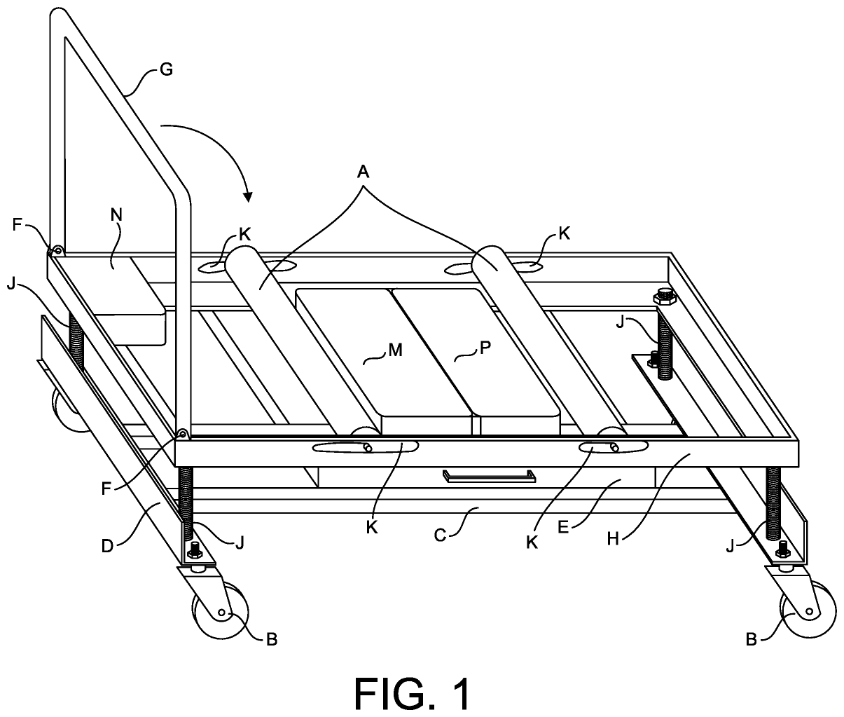

FIG. 1 is a perspective view of the Easy Wheel Mount apparatus in accordance with an embodiment of the present disclosure. The view shows: A. Tire holder rollers, B. Caster wheels, C. Aluminum or durable plastic support, and D. Aluminum or durable plastic frame in accordance with an embodiment of the present disclosure. The view also includes the tool drawer E, the hinge or pivot F for the folding handle G, the upper platform H, the raising and lowering devices J which are springs in some embodiments, the slots K for adjusting the space between the rollers A, the motor M and the pnuematics P and the controller N for control of the mechanization of the wheel mount apparatus as claimed in an embodiment of the disclosure.

The aforementioned invention raises the tire and assists in rolling it into position with the wheel studs, thereby eliminating arduous physical strain. It is made of a sturdy, durable plastic or aluminum material with caster wheels for easy mobility and rollers to line up the wheel to the wheel studs. There is a lever underneath the platform that raises the wheel/tire for mounting.

The user simply places the tire on the platform's two rollers. The platform has springs which raise and lower the tire to align it to the studs. The user can easily move the tire with the rollers for this. Once the tire is aligned to the studs, then the user can push it onto the wheel studs and remove the platform.

The platform has springs to raise and lower the tire to the desired height making alignment of tire and studs more efficient. The rollers a user sets the tire on are also adjustable for different diameter tires.

The platform has caster wheels allowing it to be set up like a car dolly, along the outside of the platform, so that one can put longer bolts and longer springs to increase the up and down (raising and lowering) motion.

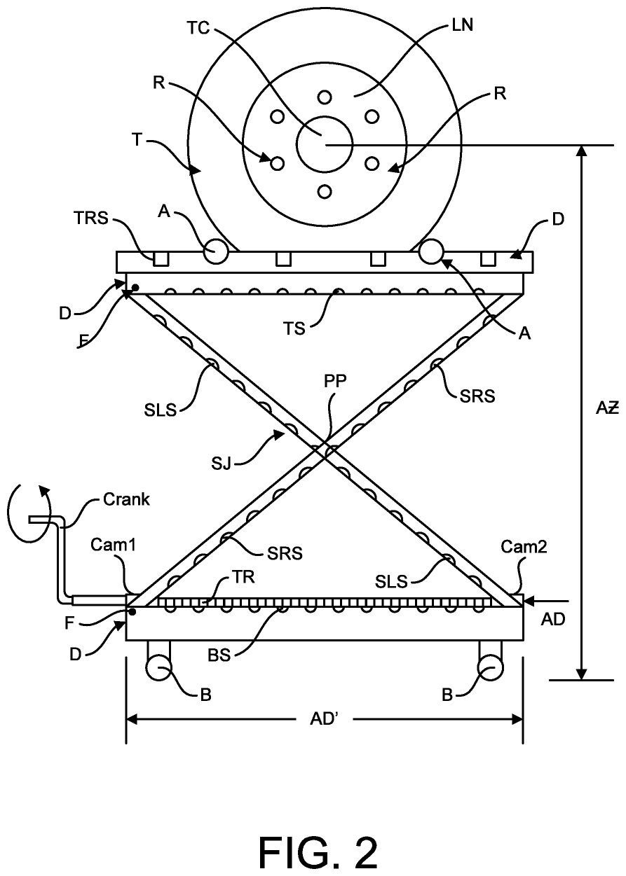

FIG. 2 is a perspective view of an improved Easy Wheel Mount apparatus in accordance with an embodiment of the present disclosure. The view includes the wheel hub lugs and rim lug holes on the wheel hub lug LN and the rim R of the tire T. The view also includes the slots TS on the upper platform and the slots BS on the lower platform of the support structure D. The crossing members of the scissor lift or scissor jack SJ comprise SLS scissor left slots and SRS scissor right slots. The crossing PP or pivot point of the crossing members includes embodiments of partial fixed pivot relation and fully adjustable pivot relation via the respective slots therein. The TRS are adjustable roller slots for the rollers A depending on a diameter of a tire to be dismounted and mounted via the disclosure. The pin or hinge F fixes a component in relation to another and is dependable on the embodiment manufactured and sold by the inventor, patentee and their assignees. A height AZ of the scissor lift in relation to a center of the tire TC on the vehicle is adjustable via a respective slot receiving a complementary pin on a component or an end of the respective component. The castor wheels B enable a movement of the disclosure in aligning lugs on the wheel hub to lug holes in the rim.

An operator of the disclosure jacks up the vehicle and rolls the scissor lift and component devices under the tire of the vehicle. The operator raises the scissor jack until the rollers hit the bottom of the tire. The operator removes the lug nuts and rolls the tire on the disclosure out from under the vehicle. The tire is then serviced or replaced by sliding the tire back onto the rollers and onto the lugs where the lug nuts are reattached and retightened. The scissor lift is already at the correct height or a memory records and adjusts a predetermined height. The tire is rolled on the rollers of the disclosure to line up the lugs with the lug nuts thereof. Note this can all be done while the operator is sitting on a stool and can avoid kneeling and bending over for dismounting and mounting the tire or tires.

Raising and lowering operation of the scissor jack is accomplished via a threaded shaft or threaded rod TR through cams Cam1 and Cam2 on the two crossing members SRS and SLS each, the threaded shaft configured to respond to a torque force by raising and lowering the two crossing members via a crank, a ratchet and an impact gun by shortening a distance AD between the ends of the crossing members SRS and SLS as indicated with arrow AD and dimension AD′. In other words, the threaded rod TR runs through the cams CAM1 and CAM2 hingedly connected to ends of the crossing members SRS and SLS similar to the operation of a scissor jack used for automobile OEM (Original Equipment Manufacture) jacks. A shortening of the distance AD′ between the cams and the crossing members raises the platform and rollers A as the height AZ is increased. Subsequently, widening or lengthening the distance between the cams and the crossing members lowers the height AZ while widening the distance there between.

However, unlike the prior art auto jacks, the cams CAM1 and CAM2 run in a track on the lower member of the support structure D and a distance between the cams CAM1 and CAM2 is shortened at the same time as the distance AD between the ends of the crossing members SLS and SRS hingedly attached thereto. The same structure of cams and tracks is also implemented on a top member of the support structure to shorten a distance between the other ends of the crossing members. This is helpful for heavy loads and is also done simultaneously therewith.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

What is claimed is:

1. A tire mounting device for mounting a tire to a vehicle, comprising:
a pair of rollers comprising an adjustable space there between less than a diameter of the tire to enable a rotation of the tire thereon;
a support frame configured to support the pair of rollers on an upper platform in communication with a bottom platform; and
a scissor lift configured to move the upper platform from the bottom platform to align a wheel hub lug to a rim lug hole,
wherein the scissor lift comprises two crossing members adjustable in relation to each other and to the support frame.

2. The tire mounting device of claim 1, further comprising slots in the upper platform configured to allow lateral movement of the pair of rollers in the space apart.

3. The tire mounting device of claim 1, further comprising a pivoting handle on the upper platform, the pivoting handle configured to direct the tire mounting device under the control of a user.

4. The tire mounting device of claim 1, further comprising a tool drawer disposed on the lower frame.

5. The tire mounting device of claim 1, wherein one of the two crossing members is fixed in relation to the support frame and the other is adjustable thereto via slots therein.

6. The tire mounting device of claim 1, wherein a crossing of the two crossing members is adjustable in relation to the other via slots therein.

7. The tire mounting device of claim 1, wherein an operation of the scissor lift occurs via a threaded shaft on the two crossing members, the threaded shaft configured to respond to a torque force by raising and lowering the two crossing members via a ratchet and an impact gun.

8. The tire mounting device of claim 1, wherein an operation of the scissor lift occurs via springs on the two crossing members.

9. The tire mounting device of claim 1, wherein an operation of the scissor lift occurs via stepper motors attached to the two crossing members.

10. The tire mounting device of claim 1, wherein a crossing of the two crossing members is fixed and a relation of both the crossing members to the support frame is adjustable via slots therein.

11. The tire mounting device of claim 1, further comprising notched slots in the upper platform configured to allow a lateral movement at a notch interval of the pair of rollers in the space apart.

12. The tire mounting device of claim 1, further comprising a mechanization of castor wheels on the bottom platform to operate under a control of the user.

13. The tire mounting device of claim 1, further comprising a mechanization of the adjustable space between the pair of rollers.

14. The tire mounting device of claim 1, further comprising a mechanized turning of the pair of rollers to facilitate alignment of wheel hub lugs to rim lug holes.
